(19) United States
(12) Patent Application Publication
(10) Pub. No.: US 2001/0036251 A1
(43) Pub. Date: Nov. 1, 2001

(54) Joining device between two structural features having arelative mobility, and an apparatus having such a joining device

(76) Inventors: Francis Guerit, Levainville (FR); Christian LeBlach, Conflans Sainte Honorine (FR); Francois Lenfant, Rocquencourt (FR); Jean-Michel Marteau, Asnieres (FR)

Correspondence Address: General Electric Company, 3135 Easton Turnpike - W3C, Fairfield, CT, 06431, US

(21) Appl. No.: 09/802,103

(22) Filed: Mar. 8, 2001

(30) Foreign Application Priority Data
Mar. 10, 2000 (FR) 0003130

(51) Int. Cl. H05G 1/02; F16D 1/00

(52) U.S. Cl. 378/193; 403/291

(57) ABSTRACT

Joining device between two covers having a relative mobility, surrounding two units comprising between them mechanical, electrical, fluid and similar connecting means, passing into apertures arranged in the covers. The device comprises a flexible hollow element that is shaped so as to surround the connecting means like a sheath, the two ends of which are joined to the apertures of the covers. The two covers are generally parallelepipedal in shape and are arranged at approximately right angles to one another. At least one of the two ends of the element in sheath form is shaped so as to be joined to the corresponding cover in at least two contiguous sides of the cover.

### CROSS REFERENCE TO RELATED APPLICATIONS

This application claims priority under 35 USC 119 of French Patent Application No. 0003130 filed Mar. 10, 2000, the entire subject matter which is incorporated by reference.

### BACKGROUND OF THE INVENTION

The present invention relates to a joining device between two structural features having a relative mobility and an apparatus having such a joining device. In particular, the present invention is directed to a joining device between two covers surrounding two structural units comprising between them mechanical or electrical or fluid and similar connecting means, passing into apertures arranged in the covers. The invention in addition relates to an x-ray apparatus which may comprise a digital detection system equipped with such a joining device.

An x-ray apparatus comprises a means of emission of an x-ray beam or radiogenic unit with an x-ray tube and a means for reception of the beam such as a solid state detector. The means for x-ray emission and the means for x-ray reception are generally supported by a mobile system with one or more axes, permitting filming or imaging at a variety of incidences.

It has been found that when an x-ray detection system using digital detection technology, an adjustment of the alignment of the detector with relation to the x-ray beam is necessary. The control system used for such alignment adjustment permits, for example, a coplanar translational motion X, Y of 20 mm, and a rotational motion of 4°.

The detector and its support are, for example, enclosed in two separate covers, the cover of the detector being mobile with relation to the fixed cover of the support. The detector is connected to its support by mechanical connecting means, electric cables, optical fibers, tubes (water, air) and similar means. a problem arises of establishing, between the two covers which are mobile with relation to one another, a junction that conceals the connecting means and which is esthetically pleasing as well as functional, namely impervious to the spattering of liquids, and easy to clean.

### BRIEF SUMMARY OF THE INVENTION

The subject matter of the invention is a device serving to establish the junction between two structural features, for example two covers, having a relative mobility and enclosing or surrounding two units including between them means for connecting passing into apertures arranged in the covers. The device comprises a flexible hollow element that is shaped so as to enclose or surround the means for connecting, the two ends of which are joined to the apertures of the covers. The subject matter of the invention is also directed to an apparatus, in particular, an x-ray apparatus, using the device.

### BRIEF DESCRIPTION OF THE DRAWINGS

An illustrative and non-limitative embodiment of the invention will be described below in greater detail with reference to the accompanying schematic drawings, wherein:

FIG. 1 is a perspective view of an x-ray apparatus having three axes;

FIG. 2 is a perspective view of the covers of the x-ray detection device of the apparatus of FIG. 1 and of the support of the detector, as well as of the joining device of these covers;

FIG. 3 is a perspective view, on a larger scale, of the joining device of FIG. 2.

### DETAILED DESCRIPTION OF THE INVENTION

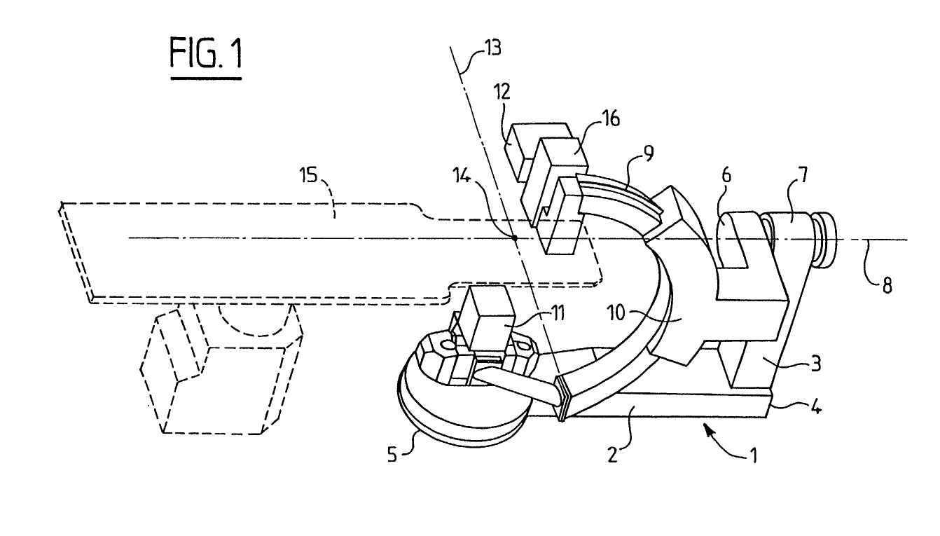

As illustrated in FIG. 1, an x-ray apparatus comprises an L-shaped stand 1, with a substantially horizontal base 2 and a substantially vertical upright 3 at one end 4 of the base 2. At the opposite end 5, the base 2 comprises an axis of rotation parallel to the upright 3 and about which the stand 1 is capable of turning. A first end of a supporting arm 6 is mounted on the top 7 of the upright 3, so as to be able to turn or rotate on a horizontal axis 8. The supporting arm 6 may have the shape of a bayonet. An arm 9, in the shape of an arc of a circle (C-shaped), is held at the other end 10 of the supporting arm 6. The C-shaped arm 9 is capable of sliding in rotational motion about an axis 13, with relation to the end 10 of the supporting arm 6.

The C-shaped arm 9 supports an x-ray tube 11 and an x-ray detector 12 in diametrically opposed facing positions. The detector 12 comprises a plane detection surface. The direction of the x-ray beam is determined by a straight line joining a focal point of the tube 11 at the center of the plane surface of the detector 12. The three axes of rotation of the stand 1, of the supporting arm 6 and of the C-shaped arm 9 are secants at a point 14. In middle position, these three axes are mutually perpendicular.

A table 15, provided for accommodating a patient, has a longitudinal orientation aligned with the axis 8 in rest position. The table 15, motorized or not, can be shifted in translation along a plurality of axes.

When the detector 12 is a digital detector, it must be able to undergo alignment adjustment with relation to the x-ray beam emitted by the tube 11. This is the reason why the detector 12 must be mobile with relation to its support 16 fixed on the C-shaped arm 9.

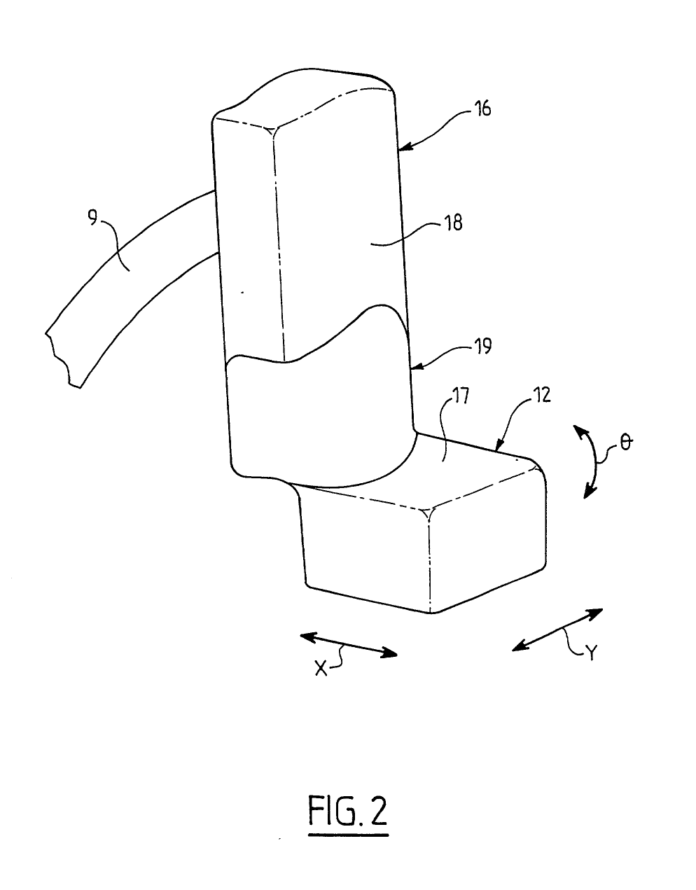

As indicated in FIG. 2, the detector 12 should be able to effect with relation to its support 16 a coplanar translational motion along X and Y of, for example 20 mm, and a rotational motion θ of, for example 4°, for purposes of alignment with the x-ray beam.

Means for connecting, such as mechanical, electrical (cables, optical fibers) and fluid (water, air), are generally needed between the detector 12 and its support 16.

When the two covers are generally parallelepipedal in shape and are arranged at approximately right angles to one another, at least one of the two ends of the element in sheath form advantageously is shaped so as to join the corresponding cover at least two contiguous sides of the cover. As shown in FIG. 2, the detector 12 is enclosed or surrounded by a cover 17 and a support 16 is surrounded by a cover 18, each of these covers being substantially parallelepipedal in shape, and the cover 17 being arranged at approximately right angles to the cover 18. The two covers 17 and 18 have apertures for passage of the aforementioned connecting means.

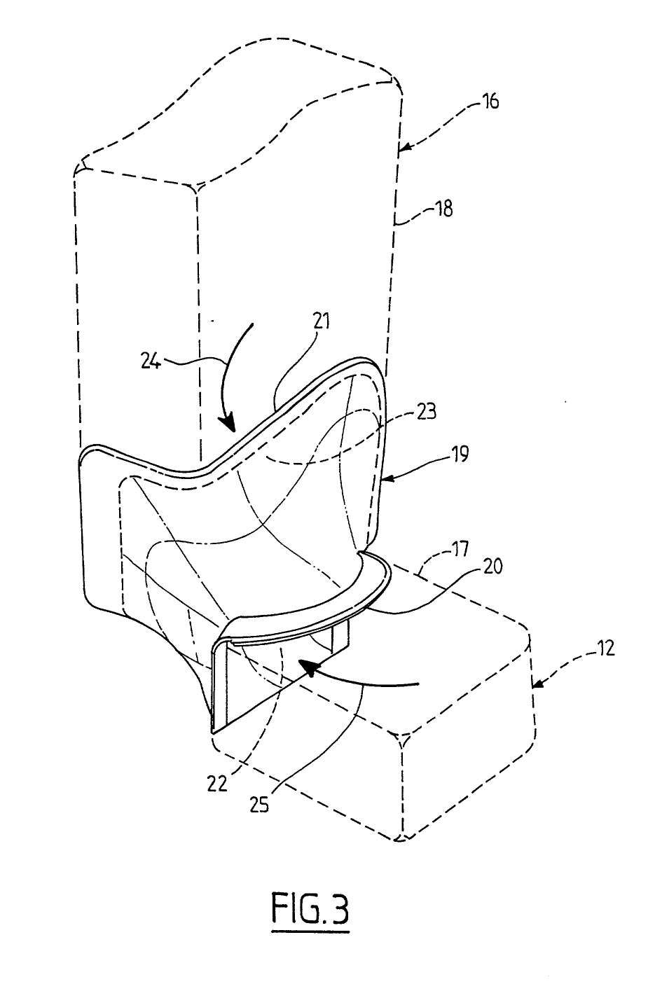

A joining device 19, which is preferably a hollow element made of flexible material, is arranged between the two covers 17 and 18, so as to preferably enclose or surround the means for connecting means like a sheath. As shown in FIG. 3, in which the joining device 19 is represented by a solid line while the covers 17 and 18 are shown in broken lines, the device 19 is shaped in such a way as to be joined at its two ends 20 and 21 to the two covers 17 and 18 at least two contiguous sides of each cover. The two covers 17 and 18 each have, for passage of the means for connecting and for joining of the two ends of the device 19, an aperture for passage 22, 23 adapted to the shape of the corresponding end of the element 19, i.e., an aperture extending in part to at least two contiguous sides of each cover. In FIG. 3, the means for connecting between the detector 12 and the support 16, enclosed respectively in the covers 17 and 18, are symbolized by arrows 24 and 25.

The device 19 is preferably formed from a material that permits it to follow the motion of the cover 17 with relation to the cover 18 while retaining an impeccable appearance, in particular without forming creases. The device 19 preferably is made of silicone, advantageously of a Shore hardness of between about 40 to 60, for example a Shore hardness of 50.

The use of silicone moreover has the advantage that the element 19 is not only impervious to the spattering of various liquids that may be encountered in x-ray rooms, for example those used in vascular radiography, namely blood, liquid disinfectants, cleaning products, etc., but is also very easy to clean.

When silicone is used, it has been found that by giving the element 19 a wall thickness of between about 2 and 3 mm, for example a thickness of 2.5 mm, for a size of the order of 300×300×300 mm, the device 19 is sufficiently flexible to retain its shape in all positions that the cover 17 may assume with relation to the cover 18 under the action of the alignment system of the digital detector 12. In particular, the device 19 is capable of following the relative motioins of the covers 17, 18 without forming creases or otherwise altering the appearance of the covers.

The two ends of the device, which may be in sheath form, are preferably fixed at the margins to the apertures of the covers. The edges of the two ends 20, 21 of the element 19 are thus tightly joined or fixed to the margins of the apertures 22, 23 of the covers 17 and 18. This joining may be effected preferably by cementing. The two ends 20, 21 of the device 19 and the margins of the apertures 22, 23 of the covers 17 and 18 may in addition advantageously have complementary profiles.

The element 19 of course may advantageously be dyed in bulk, either in the same color as the covers 17 and 18, or in a color contrasting with that of the covers.

It should be noted that the joining device, as represented and described in its application to the junction between two covers of an x-ray apparatus, may likewise be used in other fields in which the same problems arise as those described for radiology involving a limited relative mobility of two covers that must be joined tightly together.

Various modifications in structure and/or steps and/or function may be made by one skilled in the art without departing from the scope of the invention.

What is claimed is:

1. A device for joining at least two structural features having a relative mobility, the device enclosing or surrounding means for connecting structural units, the structural features having respective apertures comprising a flexible hollow element that is shaped so as to enclose or surround the means for connecting and having a respective ends which are joined to the apertures of the covers.

2. Device according to claim 1, wherein the structural features are generally parallelepipedal in shape and are arranged at an angle to one another, and at least one of two ends of the element is joined to the corresponding structural features in at least two contiguous sides of the structural feature.

3. Device according to claim 2, wherein the angle is approximately a right angle.

4. Device according to claim 1, wherein the element is in a sheath form.

5. Device according to claim 2, wherein the element is in sheath form.

6. Device according to claim 1 wherein the element is made of silicone.

7. Device according to claim 2, wherein the element is formed of a silicone material.

8. Device according to claim 4, wherein the element is made of silicone of 40 to 60 Shore hardness.

9. Device according to claim 6, wherein the silicone is 40 to 60 shore hardness.

10. Device according to claim 7, wherein the silicone is 40 to 60 shore hardness.

11. Device according to claim 5, wherein the element is composed of silicone of about 50 Shore hardness.

12. Device according to claim 9 wherein the element is formed of silicone of about 50 shore hardness.

13. Device according to claim 10, wherein the element is formed of silicone of about 50 shore hardness.

14. Device according to claim 4, wherein the element has a thickness of between about 2 and 5 mm.

15. Device according to claim 8, wherein the element has a thickness of between about 2 and 5 mm.

16. Device according to claim 14, wherein the element in sheath form has a thickness of about 2.5 mm.

17. Device according to claim 15, wherein the element has a thickness of about 2.5 mm.

18. Device according to claim 1, wherein the two ends of the element and margins of the apertures of the structural features have complementary profiles.

19. Device according to claim 2, wherein the two ends of the element and margins of the apertures of the structural feature have complementary profiles.

20. Device according to claim 1, wherein the ends of the element are cemented at margins of the apertures of the covers.

21. Device according to claim 2, wherein the ends of the element are cemented at margins of the apertures of the structural features.

22. Device according to claim 1, wherein respective ends of the element are fixed to respective structural features.

23. Device according to claim 2, wherein respective ends of the element are fixed to respective structural features.

24. Device according to claim 1, wherein the means for connecting comprises mechanical or electrical or fluid connections between the structural units.

25. A device for forming a junction between at least two covers, the covers having relative mobility with respect to each other, the covers having an aperture at respective ends, the device surrounding two structural units being at an angle to each other and having means for connecting the structural units, comprising a flexible hollow element formed of a silicone having a 40 to 60 shore hardness.

26. Device according to claim 25, wherein the element has a thickness between 2 and 5 mm.

27. Device according to claim 25 wherein the covers are substantially parallelepidal in shape.

28. Device according to claim 25 wherein the angle is approximately a right angle.

29. An x-ray apparatus having an x-ray detector and means for support of the detector, the detector and the means for support are surrounded or enclosed in separate respective covers the detector being mobile to the means for support, the detector and the means for support being connected together by means for connecting that traverse apertures of the covers, the means for connecting being surrounded by a hollow flexible element having respective ends which are joined to margins of the apertures of the covers.

30. The apparatus of claim 29 wherein the element is formed of silicone of 40 to 60 shore hardness and a thickness of between 2 and 5 mm.

31. The apparatus of claim 29 wherein the respective ends of the element and the margins of the apertures have complementary profiles.
